(19) United States
(12) Patent Application Publication
(10) Pub. No.: US 2013/0238101 A1
(43) Pub. Date: Sep. 12, 2013

(54) LOAD INERTIA ESTIMATION METHOD AND CONTROL PARAMETER ADJUSTMENT METHOD

(71) Applicants: Hirohisa Kuramoto, Minato-ku (JP); Yasunari Yamada, Minato-ku (JP)

(72) Inventors: Hirohisa Kuramoto, Minato-ku (JP); Yasunari Yamada, Minato-ku (JP)

(73) Assignee: MITSUBISHI HEAVY INDUSTRIES, LTD., Tokyo (JP)

(21) Appl. No.: 13/822,936

(22) PCT Filed: Oct. 5, 2011
(86) PCT No.: PCT/JP2011/072917

§ 371 Date: May 31, 2013

(30) Foreign Application Priority Data
Oct. 18, 2010 (JP) 2010-233249

(51) Int. Cl. G01L 5/00; G05B 11/01

(52) U.S. Cl. CPC G01L 5/00; G05B 11/01
USPC 700/19; 702/41

(57) ABSTRACT

The purpose of the present invention is to provide a method for estimating load inertia and a method for adjusting control parameters. To achieve this aim, a load position control test is performed in a load position control system, based on a feedback control system (21) and a first position deviation (Δθ) generated at a prescribed load position (θ_{L}) is estimated. Then, in a load inertia estimation model (60) which is a model of a load position control system, a load position control simulation of a feed system model is performed based on a feedback control system model, a load inertia (J_{L}) included in the feed system model is adjusted, and the load position control simulation repeated until a second position deviation (Δθ) that generated at this time at the prescribed load position equals the first position deviation. As a result, the load inertia for the feed system model at that time is estimated to be the load inertia for a feed system in an actual machine if the second position deviation equals the first position deviation. In addition, coefficients (a3-a5) for an inverse characteristic model (50) are set using this estimated load inertia.

### TECHNICAL FIELD

The present invention relates to a load inertia estimation method and a control parameter adjustment method applicable to industrial machines such as machine tools.

### BACKGROUND ART

Feedback control which is a classical control theory is generally used for load position control of a feed system in an industrial machine such as a machine tool.

FIG. 4 shows an example of a machine tool. The machine tool of the illustrated example is a double column type machining center which includes a bed 1, a table 2, a gate-shaped column 3, a crossrail 4, a saddle 5, a ram 6, and a main spindle 7.

The table 2 is disposed on the bed 1 and the column 33 is disposed in such a manner as to straddle the table 2. A workpiece W is mounted on the table 2 at the time of machining, and the table 2 moves linearly in an X-axis direction along guiderails 1a on the bed 1 with the assistance of a feed system (not shown in FIG. 4, see FIG. 5). The crossrail 4 moves linearly in a Z-axis direction along guiderails 3b on a column front face 3a with the assistance of a feed system (not shown). The saddle 5 moves linearly in a Y-axis direction along guiderails 4b on a crossrail front face 4a with the assistance of a feed system (not shown). The ram 6 is provided on the saddle 5 and moves linearly in the Z-axis direction with the assistance of a feed system (not shown). The main spindle 7 is supported rotatably inside the ram 6, and a tool 9 is fitted onto a tip of the main spindle 7 via an attachment 8.

Accordingly, when the workpiece W is machined with the tool 9, the tool 9 is driven to rotate by the main spindle 7. The main spindle 7 and the tool 9 move linearly in the Z-axis direction together with the crossrail 4 or the ram 6 and move linearly in the Y-axis direction together with the saddle 5, and the table 2 and the workpiece W move linearly in the X-axis direction. In order to achieve high-precision machining of the workpiece W at this time, positions to which the main spindle 7 (the tool 9) and the table 2 (the workpiece W) are moved are required to be precisely controlled by the feedback control.

FIG. 5 shows a general configuration example of a feedback control system and a feed system. Although detailed description is omitted herein, a feed system 11 for the table 2 shown in FIG. 5 includes a servo motor 12, a reduction gear unit 13, brackets 14, a ball screw 15 (a screw portion 15c and a nut portion 15b), and so forth. The feed system 11 moves the table 2 and the workpiece W linearly in the X-axis direction. A feedback control system 16 controls this feed system 11 as follows. Specifically, the feedback control system 16 controls rotation of the servo motor 12 in such a way that a load position θ_{L}, which is a position of the table 2 (the workpiece W) detected with a position detector 6, follows a position command θ issued from a numerical control (NC) device 17.

However, it is difficult to achieve a sufficient following performance with the feedback control system 16 as in the illustrated example, and a delay of the load position θ_{L} in following the position command θ (namely, a delay in the load position) occurs as a consequence. In order to deal with the follow delay (the delay in the load position), it is a common practice to add, to the feedback control system 16, a feed-forward control function, which is not illustrated, to differentiate the position command θ and compensate for a position delay.

However, addition of the feed-forward control function to the feedback control system cannot compensate for a position delay or vibration caused by dynamic deformation such as deflection or torsion that occurs in a mechanical element in a controlled object. For example, in the case of the feed system 11 in FIG. 5, rigidity of the screw portion 15c of the ball screw 15 has a limitation and thus torsion or deflection corresponding to load inertia (the weight of a workpiece) or the load position θ_{L} occurs in the screw portion 15c at the time of moving the table 2. The feed-forward control function cannot compensate for the follow delay of the load position θ_{L} thus caused.

In this context, Patent Document 1 listed below discloses a technique for compensating for a delay in a load position or a delay in a velocity caused by torsion or deflection of a ball screw in a feed system by finding a characteristic model (a transfer function) that approximates a characteristic of the feed system, then finding an inverse characteristic model (an inverse transfer function) of the characteristic model, and adding the inverse characteristic model to a feedback control system (see FIG. 1 and FIG. 2: to be described later in detail). Meanwhile, such techniques for adding an inverse characteristic model of a controlled object to a control system are also disclosed in Patent Documents 2 and 3 listed below, for instance.

### PRIOR ART DOCUMENTS

### Patent Documents

Patent Document 1: Japanese Patent Application Publication No. 2009-201169
Patent Document 2: Japanese Patent No. 3351990
Patent Document 3: Japanese Patent No. 3739746
Patent Document 4: Japanese Patent No. 4137673

### SUMMARY OF THE INVENTION

### Problems to be Solved by the Invention

However, in FIG. 5, the weight of the table 2 remains constant whereas the weight of the workpiece W varies depending on the type of a machined product and the like. Accordingly, the load inertia to be determined by the weight of the table 2 and the weight of the workpiece W also varies with a change in the weight of the workpiece W.

As a consequence, if the load inertia included in the inverse characteristic model (the inverse transfer function) of the feed system is always set to a constant value, then the load inertia included in the inverse characteristic model of the feed system differs from actual load inertia of the feed system when the workpiece W having a different weight from the constant value is mounted on the table 2 for machining. Accordingly, even when the inverse characteristic model of the feed system is added to the feedback control system, the inverse characteristic model cannot sufficiently compensate for the follow delay of the load position θ_{L} caused by torsion, deflection or the like of the ball screw 15 when the workpiece W having a different weight from the constant value is machined. Hence, a position deviation between the position command P and the load position θ_{L} is increased. As a consequence, the workpiece W cannot be machined at high precision.

For this reason, in order to enable the feedback control system, to which the inverse characteristic model of the feed system is added, to perform high-precision machining on the workpiece W having any weight, it is necessary to estimate the load inertia corresponding to the weight of the workpiece W and to adjust the load inertia included in the inverse characteristic model of the feed system based on the estimated load inertia.

In view of the aforementioned circumstances, it is an object of the present invention to provide a load inertia estimation method of estimating load inertia corresponding to the weight of a workpiece, and a control parameter adjustment method of adjusting load inertia included in an inverse characteristic model of a feed system based on the estimated load inertia.

Incidentally, the above-mentioned Patent Document 4 discloses a method of calculating the weight of a load by using a difference between a motor torque when no load is applied and a motor torque when a load is applied. In contrast, the method of the present invention estimates the load inertia based on a position deviation and so forth.

### Means for Solving the Problems

A load inertia estimation method according to a first aspect of the invention for solving the above problems is a load inertia estimation method of estimating load inertia of a feed system for a load position control system configured to cause a feedback control system, to which an inverse characteristic model of the feed system is added, to control a load position of the feed system on the basis of an amount of compensation outputted from the inverse characteristic model and used for compensating for a dynamic error factor of the feed system. The method is characterized in that the method comprises: in the load position control system, conducting a load position control test using the feedback control system by issuing a position command to the feedback control system, and measuring a position deviation between the position command and the load position arising at a prescribed load position at this time; and in a load inertia estimation model being a model of the load position control system, conducting load position control simulation on a model of the feed system using a model of the feedback control system by issuing the position command to the model of the feedback control system, repeating the load position control simulation while the load inertia included in the model of the feed system is adjusted until a position deviation between the position command and the load position arising at the prescribed load position in the load position control simulation becomes equal to the position deviation measured in the load position control test, and as a consequence, if the position deviation arising at the prescribed load position in the load position control simulation becomes equal to the position deviation measured in the load position control test, estimating the load inertia included in the model of the feed system at this time as the load inertia of the feed system.

In addition, a load inertia estimation method according to a second aspect of the invention is a load inertia estimation method of estimating load inertia of a feed system for a load position control system configured to cause a feedback control system, to which an inverse characteristic model of the feed system is added, to control a load position of the feed system on the basis of an amount of compensation outputted from the inverse characteristic model and used for compensating for a dynamic error factor of the feed system. The method is characterized in that the method comprises: in the load position control system, conducting a load position control test using the feedback control system by issuing a position command to the feedback control system and measuring a position deviation between the position command and the load position arising at a prescribed load position at this time, or in a model of the load position control system, conducting load position control simulation on a model of the feed system using a model of the feedback control system by issuing the position command to the model of the feedback control system and measuring the position deviation between the position command and the load position arising at the prescribed load position at this time; and finding load inertia corresponding to the position deviation measured in the load position control test or the load position control simulation on the basis of position deviation characteristic data which is preset based on the position deviation between the position command and the load position being measured in advance and arising at the prescribed load position when no load is applied and on the position deviation between the position command and the load position being measured in advance and arising at the prescribed load position when a certain load is applied and which increases linearly in proportion to an increase in the load inertia, and estimating the load inertia thus found as the load inertia of the feed system.

Further, a control parameter adjustment method according to a third aspect of the invention is a control parameter adjustment method of adjusting load inertia included in an inverse characteristic model for a load position control system configured to cause a feedback control system, to which the inverse characteristic model of a feed system is added, to control a load position of the feed system on the basis of an amount of compensation outputted from the inverse characteristic model and used for compensating for a dynamic error factor of the feed system. The method is characterized in that the method comprises adjusting the load inertia included in the inverse characteristic model on the basis of the load inertia estimated by the load inertia estimation method according to the first or second aspect.

### Effect of the Invention

The load inertia estimation method of the first aspect of the invention provides the method of estimating the load inertia of the feed system for the load position control system configured to cause the feedback control system, to which the inverse characteristic model of the feed system is added, to control the load position of the feed system on the basis of the amount of compensation outputted from the inverse characteristic model and used for compensating for the dynamic error factor of the feed system. Here, the method is characterized in that the method includes, in the load position control system, conducting a load position control test using the feedback control system by issuing a position command to the feedback control system, and measuring a position deviation between the position command and the load position arising at a prescribed load position at this time; and in a load inertia estimation model being a model of the load position control system, conducting load position control simulation on a model of the feed system using a model of the feedback control system by issuing the position command to the model of the feedback control system, repeating the load position control simulation while the load inertia included in the model of the feed system is adjusted until a position deviation between the position command and the load position arising at the prescribed load position in the load position control simulation becomes equal to the position deviation measured in the load position control test, and as a consequence, if the position deviation arising at the prescribed load position in the load position control simulation becomes equal to the position deviation measured in the load position control test, estimating the load inertia included in the model of the feed system at this time as the load inertia of the feed system. For this reason, even when the weight of a load on the feed system (such as the weight of a workpiece mounted on a table of a machine tool) varies, the load inertia corresponding to the load weight can easily be estimated.

The load inertia estimation method of the second aspect of the invention provides the method of estimating the load inertia of the feed system for the load position control system configured to cause the feedback control system, to which the inverse characteristic model of the feed system is added, to control the load position of the feed system on the basis of the amount of compensation outputted from the inverse characteristic model and used for compensating for the dynamic error factor of the feed system. Here, the method is characterized in that the method includes, in the load position control system, conducting a load position control test using the feedback control system by issuing a position command to the feedback control system and measuring a position deviation between the position command and the load position arising at a prescribed load position at this time, or in a model of the load position control system, conducting load position control simulation on a model of the feed system using a model of the feedback control system by issuing the position command to the model of the feedback control system and measuring the position deviation between the position command and the load position arising at the prescribed load position at this time; and finding load inertia corresponding to the position deviation measured in the load position control test or the load position control simulation on the basis of position deviation characteristic data which is preset based on the position deviation between the position command and the load position being measured in advance and arising at the prescribed load position when no load is applied and on the position deviation between the position command and the load position being measured in advance and arising at the prescribed load position when a certain load is applied and which increases linearly in proportion to an increase in the load inertia, and estimating the load inertia thus found as the load inertia of the feed system. For this reason, even when the load weight on the feed system (such as the weight of the workpiece mounted on the table of the machine tool) varies, the load inertia corresponding to the load weight can easily be estimated.

The control parameter adjustment method according to the third aspect of the invention provides the control parameter adjustment method of adjusting the load inertia included in the inverse characteristic model for the load position control system configured to cause the feedback control system, to which the inverse characteristic model of the feed system is added, to control the load position of the feed system on the basis of the amount of compensation outputted from the inverse characteristic model and used for compensating for the dynamic error factor of the feed system. Here, the method is characterized in that the method includes adjusting the load inertia included in the inverse characteristic model on the basis of the load inertia estimated by the load inertia estimation method according to the first or second aspect of the invention. Therefore, even when the load weight on the feed system (such as the weight of the workpiece mounted on the table of the machine tool) varies, it is possible to cause parameters of the feed system to match parameters of the inverse characteristic model (such as coefficients (to be described later in detail) in differential terms of third and higher orders including the term of the load inertia). For this reason, it is possible to perform precise control over the load position such that the load position follows the position command, and thereby to cause, for example, a machine tool to perform high-precision machining.

### BRIEF DESCRIPTION OF THE DRAWINGS

FIG. 1 is a view showing a configuration of a load position control system which embodies a load inertia estimation method and a control parameter adjustment method according to a first embodiment of the present invention.

FIG. 2 is a view showing a configuration of a load inertia estimation model.

FIG. 3 is a view showing a configuration of a load position control system which embodies a load inertia estimation method and a control parameter adjustment method according to a second embodiment of the present invention.

FIG. 4 is a view showing a configuration of a conventional machine tool.

FIG. 5 is a view showing a configuration of a conventional load position control system (a feedback control system and a table feed system).

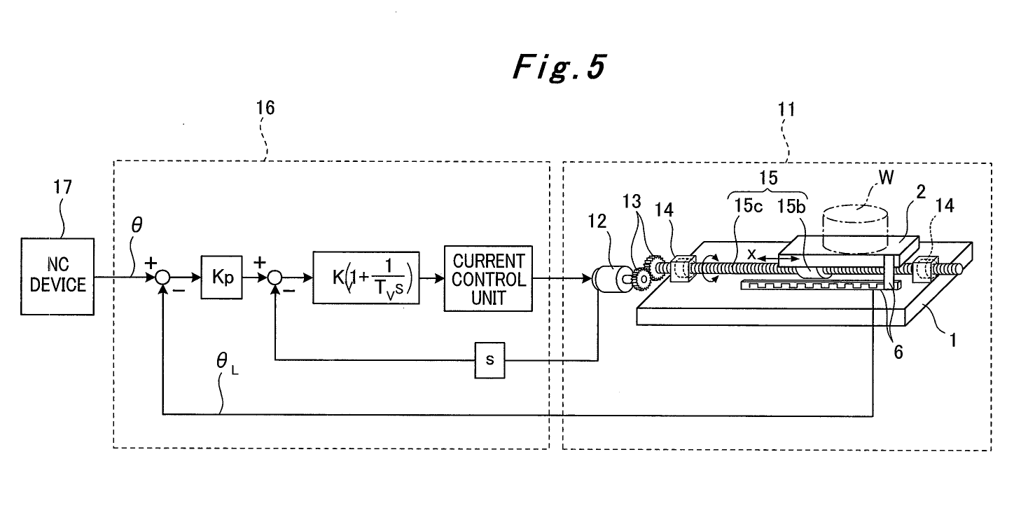

### MODES FOR CARRYING OUT THE INVENTION

Embodiments of the present invention will be described below in detail based on the drawings.

### First Embodiment

(Description of Feedback Control System and Feed System)

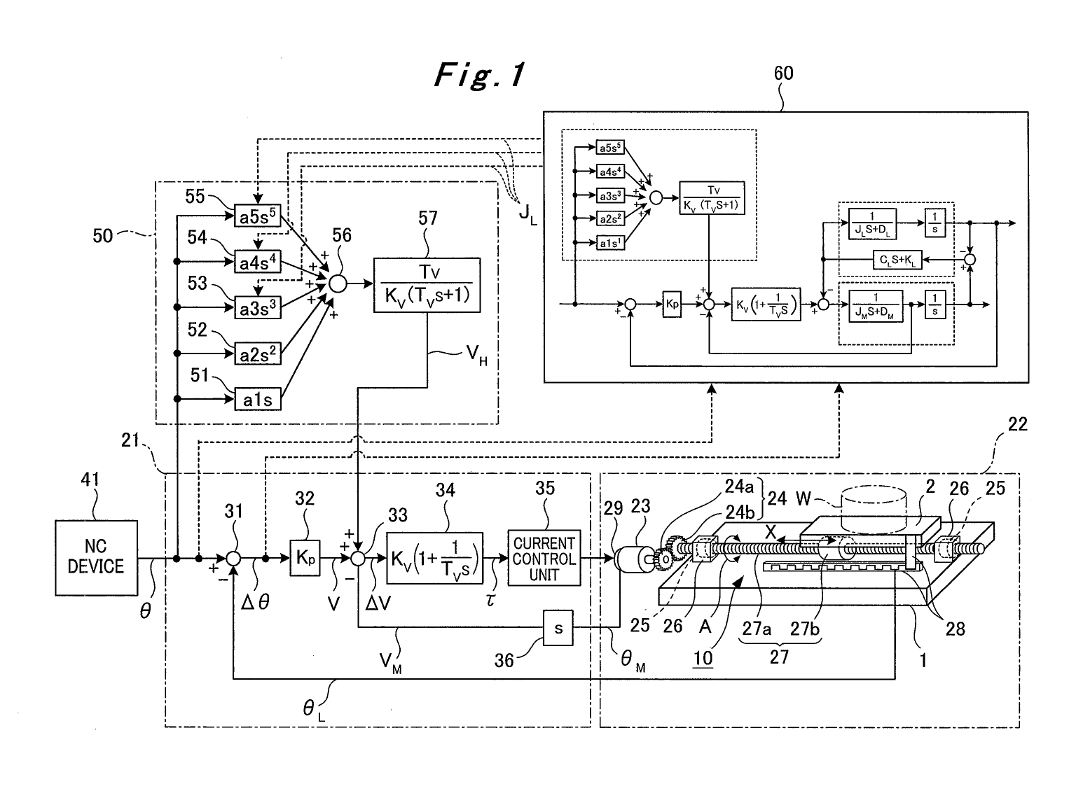

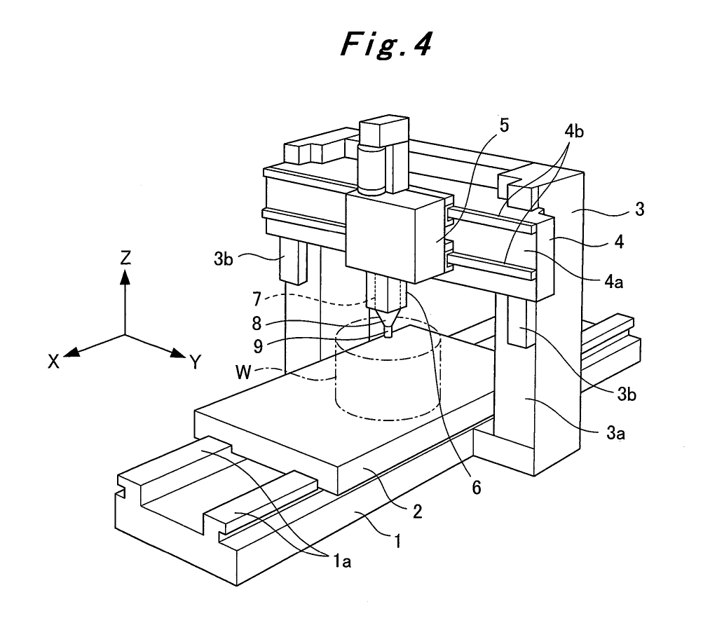

A configuration of a load position control system (a feedback control system 21 and a feed system 22) of a machine tool (see FIG. 4) which embodies a load inertia estimation method and a control parameter adjustment method according to an embodiment of the present invention will be described based on FIG. 1.

As shown in FIG. 1, the table feed system 22 includes a servo motor 23 being a drive source, a reduction gear unit 24 having a motor end gear 24a and a load end gear 24b, brackets 26 each incorporating a bearing 25, a ball screw 27 having a screw portion 27a and a nut portion 27b, a position detector 28, and a pulse encoder 29.

The brackets 26 on two sides are fixed to a bed 1 and rotatably support the screw portion 27a of the ball screw 27 via the bearings 25. The nut portion 27b of the ball screw 27 is attached to the table 2 and screwed to the screw portion 27a. The servo motor 23 is connected to the screw portion 27a of the ball screw 27 via the reduction gear unit 24. A workpiece W is placed on the table 2. In addition, the position detector (which is an Inductosyn linear scale in the illustrated example) 28 is attached to the table 2, and the pulse encoder 29 is attached to the servo motor 23.

Accordingly, when torque of the servo motor 23 is transferred to the screw portion 27a of the ball screw 27 via the reduction gear unit 24 and the screw portion 27a is rotated as indicated with an arrow A, the table 2 moves linearly in an X-axis direction together with the nut portion 27b of the ball screw 27. At this time, the position detector 28 detects a load position θ_{L}, which is a position to which the table 2 (the workpiece W) is moved, and sends a detection signal of the load position θ_{L} to the feedback control system 21 (position feedback). The pulse encoder 29 detects a motor position θ_{M} which is a rotational position of the servo motor 23. A detection signal of the motor position θ_{M} is sent to the feedback control system 21, then subjected to temporal differentiation by a differential operation unit 36, and thereby converted into a motor velocity V_{M} which is a rotational velocity of the servo motor 23 (velocity feedback).

The feedback control system 21 is constructed by software to be executed by a personal computer, for example, and includes a position deviation operating unit 31, a multiplication unit 32, a velocity deviation operating unit 33, a proportional integral operating unit 34, a current control unit 35, and a differential operating unit 36.

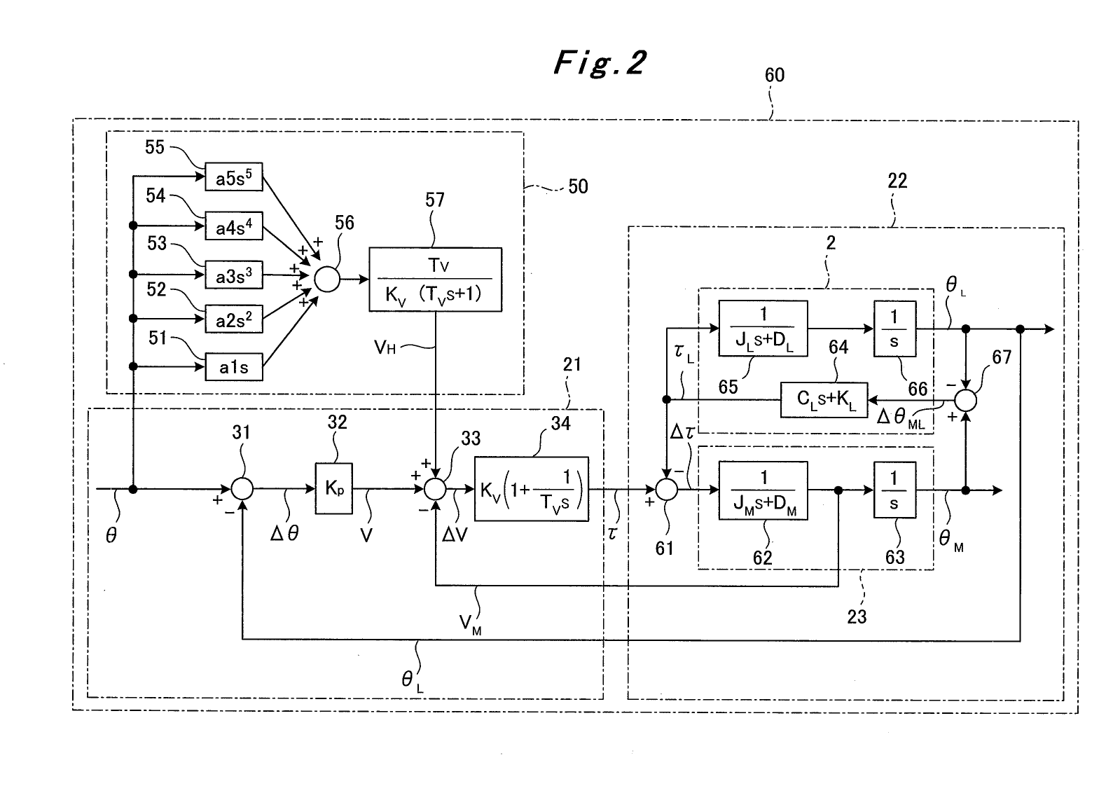

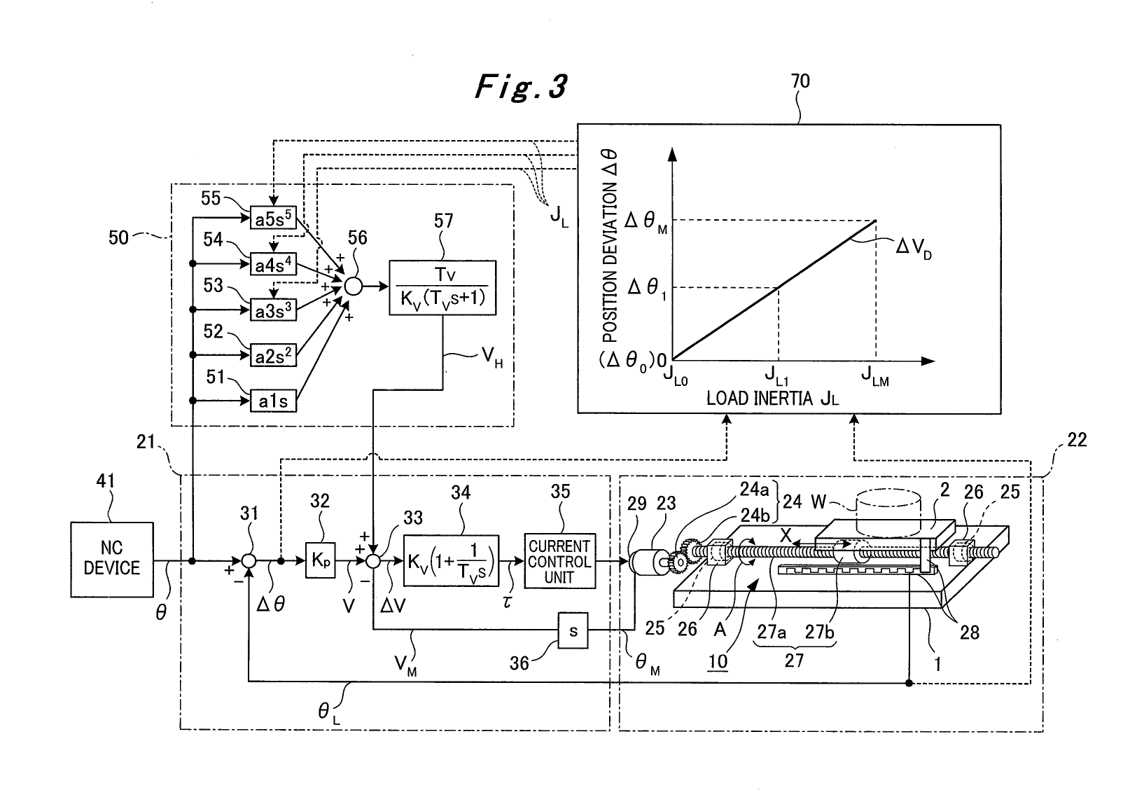

Moreover, an inverse characteristic model 50 of the feed system 22 of the table 2 is added to the feedback control system 21. Although the details will be described later, the inverse characteristic model 50 is an inverse characteristic model (an inverse transfer function) of a characteristic model (a transfer function) that approximates a characteristic of the feed system 22, and is designed to compensate for a delay in the load position θ_{L} or a delay in a velocity caused, for instance, by torsion or deflection of the ball screw 27 (the screw portion 27a) of the feed system 22 (see FIG. 2: to be described further in detail). Here, s in FIG. 1 denotes a Laplace operator, namely, is a first-order differential, s² is a second-order differential, s³ is a third-order differential, s⁴ is a fourth-order differential, s⁵ is a fifth-order differential, and 1/s is an integral thereof (the similar applies to FIG. 2 and FIG. 3).

The position deviation operating unit 31 of the feedback control 21 finds a position deviation θΔ by calculating a deviation (θ−θ_{L}) between a position command θ, which is issued from a numerical control (NC) device 41 in order to control the load position θ_{L}, and the load position θ_{L}. The multiplication unit 32 finds a motor velocity command V for controlling the rotational velocity of the servo motor 23 by multiplying the position deviation Δθ by a position loop gain Kp. Meanwhile, the velocity deviation operating unit 33 finds a velocity deviation ΔV by calculating a deviation (V+V_{H}−V_{M}) between a value (V+V_{H}), which is obtained by adding the amount V_{H} of velocity compensation outputted from the inverse characteristic model 5 to the motor velocity command V, and the motor velocity V_{M}.

The proportional integral operating unit 34 finds a motor torque command τ to the servo motor 23 by performing a proportional integral operation of τ−ΔV×(K_{V}(1+1/(T_{V}s))) using a velocity loop gain K_{V} and an integration time constant T_{V}. The current control unit 35 controls a current to be supplied to the servo motor 23 in such a way that the torque generated by the servo motor 23 follows the motor torque command τ. Although illustration is omitted, the current control unit 35 performs feedback control on the current such that the supply current to the motor 23 becomes a current that corresponds to the motor torque command τ.

As described above, the feedback control system 21 performs the feedback control using the triple loops of the position loop serving as a main loop, and the velocity loop as well as the current loop serving as minor loops, thereby performing control such that the load position θ_{L} follows the position command θ.

(Description of Load Inertia Estimation Model)

Furthermore, in the first embodiment, a model 60 for estimating load inertia J_{L} that corresponds to the weight of the workpiece W is added to the feedback control system 21. The load inertia estimation model 60 will be described based on FIG. 2. Note that portions in FIG. 2 similar to those in FIG. 1 will be denoted by the same reference numerals and overlapping detailed description thereof will be omitted herein.

In the example shown in FIG. 2, the characteristic model (the transfer function) approximating the characteristic of the feed system 22 is specified as a two-mass-point mechanical system model defining the servo motor 23 as one mass point, and the table 2 and the workpiece W collectively serving as the load on the motor as another mass point. Further, the load inertia estimation model 60 includes the characteristic model (the transfer function) of the feed system 22, the inverse characteristic model (the inverse transfer function) 50 of the characteristic model, and a model (a transfer function) of the feedback control system 21.

As shown in FIG. 2, when a characteristic model of the servo motor 23 is expressed by transfer functions, the characteristic model is expressed by a transfer function (1/(J_{M}s+D_{M})) in a block 62 and a transfer function (1/s) in a block 63. Here, J_{M} is motor inertia and D_{M} is motor viscosity. The motor velocity V_{M} is outputted from the block 62 while the motor position θ_{M} is outputted from the block 63.

When a characteristic model of the table 2 inclusive of the ball screw 27 is expressed by transfer functions, the characteristic model is expressed by a transfer function (C_{L}s+K_{L}) in a block 64, a transfer function (1/(J_{L}s+D_{L})) in a block 65, and a transfer function (1/s) in a block 66. Here, J_{L} is load inertia, which is the inertia determined by the weight (a constant value) of the table 2 and the weight of the workpiece W mounted on the table 2. Therefore, when the weight of the workpiece W mounted on the table 2 varies, the load inertia J_{L} also changes accordingly. Here, D_{L} is viscosity of the load (the table), C_{L} is spring viscosity of the ball screw 27 unit (the screw portion 27a, the nut portion 27b, and the brackets 26) in an axial direction, and K_{L} is spring rigidity of the ball screw 27 unit (the screw portion 27a, the nut portion 27b, and the brackets 26) in the axial direction.

A position deviation operating unit 67 finds a position deviation Δθ_{ML} by calculating a deviation (θ_{M}−θ_{L}) between the motor position θ_{M} and the load position θ_{L}. When the position deviation Δθ_{ML} is inputted, the block 64 finds reactive torque τ_{L} by performing calculation of τ_{L}=Δθ_{ML}×(C_{L}s+K_{L}) and outputs the reactive torque τ_{L}. When the reactive torque τ_{L} is inputted to the block 65, the load position θ_{L} is found by performing calculation of θ_{L}=τ_{L}(1/(J_{L}s+D_{L}))×(1/s) in the block 65 and the block 66, and the load position θ_{L} is outputted from the block 66.

A torque deviation operating unit 61 finds a torque deviation Δτ by calculating a deviation (τ−τ_{L}) between the torque command τ and the reactive torque τ_{L}. The block 62 finds the motor velocity V_{M} by performing calculation of V_{M}=Δτ×(1/(J_{M}s+D_{M})). The motor velocity V_{M} is outputted to the block 63 and fed back to the velocity deviation operating unit 33 of the feedback control system 21. The block 63 finds the motor position θ_{M} by performing calculation of θ_{M}=V_{M}×(1/s). The motor position θ_{M} is outputted to the position deviation operating unit 67. The load position θ_{L} is fed back to the position deviation operating unit 31 of the feedback control system 21.

The inverse characteristic model 50 includes a first-order differential term operating unit 51, a second-order differential term operating unit 52, a third-order differential term operating unit 53, a fourth-order differential term operating unit 54, a fifth-order differential term operating unit 55, an addition unit 56, and a proportional integral inverse transfer function unit 57.

A transfer function for compensation control, which is provided for performing compensation control in such a manner as to compensate for dynamic error factors at the servo motor 23, the ball screw 27, and the table 2 of the feed system 22 and thereby to cause the load position θ_{L} to match (follow) the position command θ, is set to each of the differential term operating units 51 to 55 and the addition unit 56. The transfer functions for compensation control are inverse transfer functions of the aforementioned transfer functions of the feed system 22 (a mechanical system including the servo motor 23, the ball screw 27, and the table 2). Note that the inverse transfer functions are formed as functions where operational elements are partially curtailed.

Specifically, the differential term operating units 51 to 55 of the inverse characteristic model 50 include operands a1s, a2s², a3s³, a4s⁴, and a5s⁵, respectively. The differential term operating units 51 to 55 multiply the position command θ by the operands a1s, a2s², a3s³, a4s⁴, and a5s⁵, respectively, and output multiplied values to the addition unit 56. The addition unit 56 adds the multiplied values outputted from the differential term operating units 51 to 55.

The coefficients a1, a2, a3, a4, and a5 in the operands a1s to a5s⁵ are set as follows. Of the terms included in the formulae of the respective coefficients a1 to a5, K_{V} is the velocity loop gain, K_{L} is the spring rigidity of the ball screw 27 in the axial direction, τ_{V} is the integration time constant, D_{M} is the viscosity of the servomotor 23, D_{L} is the load viscosity, J_{M} is the inertia of the servomotor 23, and J_{L} is the load inertia as discussed previously.

A calculation method of setting (calculating) the coefficients a1 to a5 as below will be described later.

$$[ Expression 1 ]$$

$$a 1 = \frac{{K}_{V}}{{T}_{V}}$$

$$a 2 = {D}_{M} + {D}_{L} + {K}_{V} + \frac{{K}_{V} {D}_{L}}{{T}_{V} {K}_{L}}$$

$$a 3 = {J}_{M} + {J}_{L} + \frac{{D}_{M} {D}_{L} + {K}_{V} {D}_{L}}{{K}_{L}} + \frac{{K}_{V} {J}_{L}}{{T}_{V} {K}_{L}}$$

$$a 4 = \frac{{J}_{M} {D}_{L} + {J}_{L} {D}_{M} + {K}_{V} {J}_{L}}{{K}_{L}}$$

$$a 5 = \frac{{J}_{M} {J}_{L}}{{K}_{L}}$$

A term (T_{V}/K_{V}(T_{V}s+1)) in an inverse transfer function (T_{V}/K_{V}(T_{V}s+1))×s of the transfer function K_{V}(1+1/(T_{V}s)) of the proportional integral operating unit 34 is set to the proportional integral inverse transfer function unit 57. The differential operators in (T_{V}/K_{V}(T_{V}s+1))×s is assigned to each of the operands a1s to a5s⁵ in the differential term operating units 51 to 55.

Then, load position control of the feed system 22 is conducted while the amount V_{H} of velocity compensation outputted from the inverse characteristic model 50 including the set coefficients a1 to a5 is applied to the feedback control system 21. Thus, it is possible to compensate for error factors such as distortion, deflection, and viscosity which may occur in the servo motor 23, the ball screw 27, the table 2, and so forth of the feed system 22, and thereby to perform precise control over the load position θ_{L} such that the load position θ_{L} follows the position command θ. As a consequence, high-precision machining is enabled.

(Description of Load Inertia Estimation Method and Control Parameter Adjustment Method)

However, if the weight of the workpiece W mounted on the table 2 varies (when a workpiece W having a different weight is mounted on the table 2), the load inertia J_{L} also changes in response to the variation in the weight of the workpiece W. Hence, parameters of the feed system 22 no longer match parameters of the inverse characteristic model 50. Specifically, the coefficients a3 to a5 of the differential terms of the third and higher orders (i.e., the terms a1s³ to a5s⁵) including the term of the load inertia J_{L} do not match the corresponding parameters of the feed system 22. At this rate, the position deviation Δθ is increased whereby the load position θ_{L} causes a delay in following the position command θ.

Therefore, the load inertia J_{L} corresponding to the weight of the workpiece W is estimated in accordance with the following method prior to the machining of the workpiece W.

First, in the actual load position control system (the feedback control system 21 and the feed system 22) shown in FIG. 1, a load position control test on the feed system 22 is conducted using the feedback control system 21 by issuing the position command θ (a motion command in the X-axis direction) from the NC device 41 to the feedback control system 21 while mounting the workpiece W on the table 2. Then, the position deviation Δθ arising at this time is measured. Here, since the spring rigidity K_{L} varies depending on the load position θ_{L}, the position deviation Δθ arising at a point of time when the table 2 reaches a prescribed (predetermined) load position θ_{L} (i.e., a point of time when the table 2 reaches the load position θ_{L} where the spring rigidity becomes the prescribed spring rigidity K_{L}) is measured.

Next, in the load inertia estimation model 60 shown in FIG. 1 and FIG. 2, which is the model of the load position control system, load position control simulation on a model of the feed system 22 is conducted using a model of the feedback control system 21 by issuing the position command A (the motion command in the X-axis direction) from the NC device 41 to the model of the feedback control system 21 while mounting the workpiece W on the table 2.

Here, the load position control simulation is repeated while the load inertia J_{L} of the table 2 as well as the workpiece W included in the model of the feed system 22 are adjusted until position deviation Δθ arising in the load position control simulation becomes equal to the position deviation Δθ measured in the load position control test conducted by the actual system.

However, as described previously, the spring rigidity K_{L} varies depending on the load position θ_{L}. Accordingly, the position deviation Δθ arising at the point of time when the table 2 reaches the prescribed load position θ_{L} (i.e., the point of time when the table 2 reaches the load position θ_{L} where the spring rigidity becomes the prescribed spring rigidity K_{L}) is compared with the position deviation Δθmeasured in the load position control test conducted by the actual system to estimate whether or not both of the position deviations Δθ are mutually equal. Meanwhile, the load inertia J_{L} in the inverse characteristic model 50 at the time when the load position control test is conducted by the actual system is set to the same value as the load inertia J_{L} in the inverse characteristic model 50 at the time when the load position control simulation is conducted. For example, these values are set equal to load inertia J_{L0} when no load is applied, i.e., no workpiece W is mounted on the table 2.

If the position deviation Δθ arising in the load position control simulation becomes equal to the position deviation Δθ measured in the load position control test conducted by the actual system as a consequence of repeating the load position control simulation while adjusting the load inertia J_{L} included in the model of the feed system 22, then the load inertia J_{L} included in the model of the feed system 22 at this time is estimated as the actual load inertia J_{L} corresponding to the weight of the workpiece W mounted on the table 2.

Next, the load inertia J_{L} thus estimated is outputted from the load inertia estimation model 60 to the inverse characteristic model 50 of the actual system as shown in FIG. 1. In the inverse characteristic model 50 of the actual system, the coefficients a3 to a5 of the differential terms of the third and higher orders including the term of the load inertia J_{L} are adjusted (set) on the basis of the load inertia J_{L} outputted from the load inertia estimation model 60. In this way, the parameters of the feed system 22 match the parameters (the coefficients a3 to a5 of the differential terms of the third and higher orders including the term of the load inertia J_{L}) of the inverse characteristic model 50. For this reason, when the workpiece W is machined, it is possible to perform precise control over the load position θ_{L} such that the load position A_{L} follows the position command θ, and thereby to achieve high-precision machining.

### Operation and Effect

As described above, the load inertia estimation method of the first embodiment provides the method of estimating the load inertia J_{L} of the feed system 22 for the load position control system configured to cause the feedback control system 21, to which the inverse characteristic model 50 of the feed system 22 is added, to control the load position θ_{L} of the feed system 22 on the basis of the amount V_{H} of compensation outputted from the inverse characteristic model 50 and used for compensating for the dynamic error factor of the feed system 22. Here, the method is characterized in that the method includes: in the load position control system, conducting the load position control test using the feedback control system 21 by issuing the position command θ to the feedback control system 21, and measuring the position deviation Δθ arising at the prescribed load position θ_{L} at this time; and in the load inertia estimation model 60 being the model of the load position control system, conducting the load position control simulation on the model of the feed system 22 using the model of the feedback control system 21 by issuing the position command θ to the model of the feedback control system 21, repeating the load position control simulation while the load inertia J_{L} included in the model of the feed system 22 is adjusted until the position deviation Δθ arising at the prescribed load position θ_{L} in the load position control simulation becomes equal to the position deviation Δθ measured in the load position control test, and as a consequence, if the position deviation Δθ arising at the prescribed load position θ_{L} in the load position control simulation becomes equal to the position deviation Δθ measured in the load position control test, estimating the load inertia J_{L} included in the model of the feed system 22 at this time as the load inertia J_{L} of the feed system 22 of the actual system. For this reason, even when the weight of a load on the feed system 22 (the weight of the workpiece W mounted on the table 2) varies, the load inertia J_{L} corresponding to the load weight can easily be estimated.

In addition, the control parameter adjustment method of the first embodiment is characterized in that the method includes adjusting the load inertia J_{L} included in the inverse characteristic model 50 of the actual system on the basis of the load inertia J_{L} estimated by using the load inertia estimation method. Accordingly, even when the load weight on the feed system 22 (the weight of the workpiece W mounted on the table 2) varies, it is possible to cause the parameters of the feed system 22 to match the parameters of the inverse characteristic model 50 (the coefficients a3 to a5 of the differential terms of the third and higher orders including the term of the load inertia J_{L}). For this reason, it is possible to perform precise control over the load position θ_{L} such that the load position θ_{L} follows the position command θ, and thereby to achieve high-precision machining.

### Second Embodiment

(Description of Load Inertia Estimation Method and Control Parameter Adjustment Method)

A load inertia estimation method and a control parameter adjustment method according to a second embodiment of the present invention will be described based on FIG. 3. Note that portions in FIG. 3 similar to those in the first embodiment will be denoted by the same reference numerals and overlapping detailed description thereof will be omitted herein.

As shown in FIG. 3, a position deviation characteristic data unit 70 for estimating the load inertia J_{L} corresponding to the weight of the workpiece W is added to the feedback control system 21 in the second embodiment.

A relational expression F=ma=K_{L}Δθ (F: force, m: weight of workpiece, K_{L}: spring rigidity of ball screw, Δθ: position deviation) holds between the position deviation Δθ (i.e., deflection of the ball screw 27 and the like) and the weight of the workpiece W. When the force F and the spring rigidity K_{L} are made constant, the position deviation Δθ is thought to increase linearly in proportion to the increase in the weight of the workpiece W.

In the meantime, the amount of compensation in proportion to the load inertia J_{L} is determined for the differential terms of the third and higher orders (a3s³ to a5s⁵) in the inverse characteristic model 50. Hence, the position deviation Δθ can be thought to increase linearly in proportion to the increase in the weight of the workpiece W mounted on the table 2.

Therefore, if data on the position deviation Δθ under the load inertia J_{L0} when no load is applied, i.e., no workpiece W is mounted on the table 2 and on the position deviation Δθ under the load inertia J_{L} when a maximum load is applied, i.e., a workpiece W having a maximum probable weight is mounted on the table 2 are available, then it is possible to estimate load inertia J_{L1} at the time of mounting a workpiece W having an unknown weight on the table 2 by use of the data.

Accordingly, in the actual load position control system (the feedback control system 21 and the feed system 22) shown in FIG. 3, a load position control test is conducted using the feedback control system 21 on the feed system 22 in the cases where no load is applied and where the maximum load is applied, by issuing the position command θ (the motion command in the X-axis direction) from the NC device 41 to the feedback control system 21. Then, a position deviation Hθ_{L0} arising when no load is applied as well as a position deviation Δθ_{LM} arising when the maximum load is applied are measured.

Alternatively, using the models of the load position control system as shown in FIG. 2, load position control simulation is conducted using the model of the feedback control system 21 on the model of the feed system 22 in the cases where no load is applied and where the maximum load is applied, by issuing the position command θ (the motion command in the X-axis direction) to the model of the feedback control system 21. Then, the position deviation Δθ_{L0} arising when no load is applied as well as the position deviation Δθ_{LM} arising when the maximum load is applied are measured.

Here, as described previously, the spring rigidity K_{L} varies depending on the load position θ_{L}. Accordingly, the position deviations Δθ_{L0} and Δθ_{LM} each arising at the point of time when the table 2 reaches the prescribed (predetermined) load position θ_{L} (i.e., the point of time when the table 2 reaches the load position θ_{L} where the spring rigidity becomes the prescribed spring rigidity K_{L}) are measured.

Moreover, in order to define the position deviation Δθ_{L0} when no load is applied as a reference, the load inertia J_{L} in the inverse characteristic model 50 is set at the load inertia J_{L0} when no load is applied. As a consequence, the position deviation Δθ_{L0} when no load is applied is substantially equal to 0.

Position deviation characteristic data ΔV_{D} which increases linearly in proportion to an increase in the load inertia J_{L} is set in the position deviation characteristic data unit 70 on the basis of the position deviation Δθ_{L0} when no load is applied and the position deviation Δθ_{LM} when the maximum load is applied, which are measured in advance.

Then, the load inertia J_{L} corresponding to the weight of the workpiece W is estimated prior to the machining of the workpiece W in accordance with the following method.

First, in the actual load position control system (the feedback control system 21 and the feed system 22) shown in FIG. 3, the load position control test on the feed system 22 is conducted using the feedback control system 21 by issuing the position command θ (the motion command in the X-axis direction) from the NC device 41 to the feedback control system 21 while mounting the workpiece W on the table 2.

Then, the position deviation characteristic data unit 70 measures (inputs) the position deviation Δθ (which is Δθ₁ in the illustrated example) arising at this time. However, as described previously, the spring rigidity K_{L} varies depending on the load position θ_{L}. Therefore, the position deviation characteristic data unit 70 measures (inputs) the position deviation Δθ (which is Δθ₁ in the illustrated example) arising at the point of time when the table 2 reaches the prescribed (predetermined) load position θ_{L} (i.e., the point of time when the table 2 reaches the load position θ_{L} where the spring rigidity becomes the prescribed spring rigidity K_{L}).

Next, the position deviation characteristic data unit 70 finds the load inertia J_{L} (which is J_{L1} in the illustrated example) corresponding to the position deviation Δθ (which is Δθ₁ in the illustrated example) measured (inputted) either in the load position control test conducted by the actual system or in the load position control simulation, on the basis of the preset position deviation characteristic data ΔV_{D}, and estimates that the load inertia J_{L} (which is J_{L1} in the illustrated example) is the load inertia J_{L} corresponding actually to the weight of the workpiece W mounted on the table 2. The estimated load inertia J_{L} is outputted from the position deviation characteristic data unit 70 to the inverse characteristic model 50 of the actual system.

In the inverse characteristic model 50 of the actual system, the coefficients a3 to a5 of the differential terms of the third and higher orders including the term of the load inertia J_{L} are adjusted (set) on the basis of the load inertia J_{L} (which is J_{L1} in the illustrated example) outputted from the load inertia estimation model 60. In this way, the parameters of the feed system 22 match the parameters (the coefficients a3 to a5 of the differential terms of the third and higher orders including the term of the load inertia J_{L}) of the inverse characteristic model 50. For this reason, when the workpiece W is machined, it is possible to perform precise control over the load position θ_{L} such that the load position θ_{L} follows the position command θ, and thereby to achieve high-precision machining.

Although the position deviation characteristic data ΔV_{D} is set by using the position deviation Δθ_{LM} when the maximum load is applied in the above-described embodiment, the present invention is not limited only to this configuration. The position deviation characteristic data ΔV_{D} may be set by using a position deviation Δθ_{L} when a certain load other than the maximum load is applied. Specifically, in the state where a workpiece W having a certain weight other than the maximum weight on the table 2 (i.e., in the state where the certain load other than the maximum load is applied), the position deviation Δθ when the certain load is applied may be measured by causing the actual system to conduct the load position control test or conducting the load position control simulation as similar to the above description, and the position deviation characteristic data ΔV_{D} which increases linearly in proportion to the increase in the load inertia J_{L} may be set on the basis of the measured position deviation 48 when the certain load is applied as well as the position deviation Δθ₀ when no load is applied.

(Operation and Effect)

As described above, the load inertia estimation method of the second embodiment provides the method of estimating the load inertia J_{L} of the feed system 22 for the load position control system configured to cause the feedback control system 21, to which the inverse characteristic model 50 of the feed system 22 is added, to control the load position θ_{L} of the feed system 22 on the basis of the amount V_{H} of compensation outputted from the inverse characteristic model 50 and used for compensating for the dynamic error factor of the feed system 22. Here, the method is characterized in that the method includes: in the load position control system, conducting the load position control test using the feedback control system 21 by issuing the position command θ to the feedback control system 21, and measuring the position deviation Δθ (Δθ₁) arising at the prescribed load position θ_{L} at this time, or in the model of the load position control system, conducting the load position control simulation on the model of the feed system 22 using the model of the feedback control system 21 by issuing the position command θ to the model of the feedback control system 21, and measuring the position deviation Δθ (Δθ₁) arising at the prescribed load position θ_{L} at this time; and finding the load inertia J_{L} (J_{L1}) corresponding to the position deviation Δθ (Δθ₁) measured either in the load position control test or the load position control simulation on the basis of the position deviation characteristic data ΔV_{D} which is preset based on the position deviation Δθ (Δθ₀) being measured in advance and arising at the prescribed load position θ_{L} when no load is applied and on the position deviation Δθ (Δθ_{M}) being measured in advance and arising at the prescribed load position θ_{L} when the certain load is applied and which increases linearly in proportion to the increase in the load inertia J_{L}, and estimating the load inertia J_{L} (J_{L1}) as the load inertia J_{L} of the feed system 22 of the actual system. For this reason, even when the load weight on the feed system 22 (the weight of the workpiece W mounted on the table 2) varies, the load inertia J_{L} corresponding to the load weight can easily be estimated.

In addition, the control parameter adjustment method of the second embodiment is characterized in that the method includes adjusting the load inertia J_{L} included in the inverse characteristic model 50 of the actual system on the basis of the load inertia J_{L} estimated by using the load inertia estimation method. Accordingly, even when the load weight on the feed system 22 (the weight of the workpiece W mounted on the table 2) varies, it is possible to cause the parameters of the feed system 22 to match the parameters of the inverse characteristic model 50 (the coefficients a3 to a5 of the differential terms of the third and higher orders including the term of the load inertia J_{L}). For this reason, it is possible to perform precise control over the load position θ_{L} such that the load position θ_{L} follows the position command θᵣ and thereby to achieve high-precision machining.

In the above-described first and second embodiments, the load inertia J_{L} in the inverse characteristic model 50 is adjusted based on the estimated load inertia J_{L}. However, the present invention is not limited only to this configuration, but control parameters other than the load inertia J_{L} in the inverse characteristic model 50, such as control parameters concerning machining conditions, may also be adjusted based on the estimated load inertia J_{L}. For example, the estimated load inertia J_{L} may be outputted from the position deviation characteristic data unit 70 or the load inertia estimation model 60 to the NC device 41 as well, and control parameters to be set by the NC device 41, including acceleration and deceleration time, corner velocity and acceleration, and so forth may be adjusted based on the estimated load inertia J_{L}.

Meanwhile, the first and second embodiments have described the case of applying the present invention to the feed system 22 for the table 2. However, the present invention is not limited only to this configuration but is also applicable to feed systems provided for components other than the table 2 (such as a feed system for a saddle or a ram). For example, if the weight of the attachment 8 or the tool 9 in FIG. 4 is variable, then it is effective to apply the present invention to a feed system for the saddle 5 or the ram 6.

Moreover, the first and second embodiments have described the case of applying the present invention to the feed system 22 including the servo motor 23, the ball screw 27, and the like. However, the present invention is not limited only to this configuration but is also applicable to feed systems having other configurations (such as feed systems using a hydraulic pump, a hydraulic motor, a hydraulic cylinder, and the like).

Furthermore, the first and second embodiments have described the case of application to the feed system in a machine tool. However, the present invention is not necessarily limited only to this configuration but is also applicable to feed systems in industrial machines other than machine tools.

<Description on Calculation Method of Coefficients in Inverse Characteristic Model>

Now, the calculation method of setting (calculating) the coefficients a1 to a5 in the inverse characteristic model 50 will be described.

In the mechanical system model shown in FIG. 2, the transfer functions for the inverse characteristic model involving the torque and the velocity can be calculated as follows. First, Formula (1) and Formula (2) shown below are found from equations of motion. Here, Formula (1) is an equation of motion representing an input-output relation concerning a motor transfer function that models a characteristic of the servo motor 23, and Formula (2) is an equation of motion representing an input-output relation concerning a load transfer function that models a characteristic of the table 2 and the workpiece W collectively serving as the load.

[Expression 2]

τ−(θ_{M}−θ_{L})·(C_{L}s+K_{L})=(J_{Ms}²D_{M}s)·θ_{M} (1)

(θ_{M}−θ_{L})·(C_{L}s+K_{L})=(J_{Ls}²D_{L}s)·θ_{L} (2)

The following Formula (3) and Formula (4) are derived from Formula (1) and Formula (2) shown above.

$$\begin{matrix}[ Expression 3 ] & \\ τ = \{ \begin{matrix}\frac{{J}_{M} {J}_{L} {s}^{4} + ( {J}_{M} {D}_{L} + {J}_{L} {D}_{M} ) {s}^{3} + {D}_{M} {D}_{L} {s}^{2}}{{C}_{L} s + {K}_{L}} + \\ ( {J}_{M} + {J}_{L} ) {s}^{2} + ( {D}_{M} + {D}_{L} ) s\end{matrix} \} \cdot {θ}_{L} & ( 3 ) \\ {θ}_{M} s = ( \frac{{J}_{L} {s}^{3} + {D}_{L} {s}^{2}}{{C}_{L} s + {K}_{L}} + s ) \cdot {θ}_{L} & ( 4 )\end{matrix}$$

In order to move the load (the table 2 and the workpiece W) with no error, compensation control should be performed such that the load position θ_{L} matches the position command θ, i.e., such that θ=θ_{L} is satisfied. In order to satisfy θ=θ_{L}, the torque command τ should be subjected to feed-forward compensation control in accordance with a formula in braces { } (a first transfer function formula) on the right side of Formula (3), and the velocity command V should be subjected to feed-forward compensation control in accordance with a formula in parentheses ( ) (a second transfer function formula) on the right side of Formula (4). Note that θ_{M}s in Formula (4) is equivalent to the motor velocity V.

In Formula (3), θ_{L} is replaced with 9 and then the formula is translated into a command velocity Vi. Thus, Formula (3) is converted into Formula (5). Formula (5) is equivalent to Formula (3) multiplied by an inverse operation expression of a proportional integral operation expression set in the proportional integral operating unit 34. In other words, Formula (5) is equivalent to Formula (3) divided by the proportional integral operation expression set in the proportional integral operating unit 34. A portion on the right side of Formula (5) excluding θ constitutes a third transfer function. Meanwhile, Formula (6) shown below is obtained by replacing θ_{L} with θ in Formula (4) and then transforming Formula (4). In order to perform the compensation control such that the load position θ_{L} matches the position command θ, the compensation velocity V_{H} for achieving no error between θ and θ_{L} should be set equal to a sum of Formula (5) and Formula (6). Such a sum is expressed by Formula (7) below. A portion on the right side of Formula (7) excluding θ constitutes a fourth transfer function.

$$\begin{matrix} [ Expression 4 ] & \\ V τ = \{ \begin{matrix}\frac{{J}_{M} {J}_{L} {s}^{4} + ( {J}_{M} {D}_{L} + {J}_{L} {D}_{M} ) {s}^{3} + {D}_{M} {D}_{L} {s}^{2}}{{C}_{L} s + {K}_{L}} + \\ ( {J}_{M} + {J}_{L} ) {s}^{2} + ( {D}_{M} + {D}_{L} ) s\end{matrix} \} \cdot ( \frac{{T}_{V} s}{{K}_{V} {T}_{V} s + {K}_{V}} ) \cdot θ & ( 5 ) \\ {θ}_{M} s = ( \frac{{J}_{L} {s}^{3} + {D}_{L} {s}^{2}}{{C}_{L} s + {K}_{L}} + s ) \cdot ( \frac{{K}_{V} {T}_{V} s + {K}_{V}}{{T}_{V}} ) \cdot ( \frac{{T}_{V}}{{K}_{V} {T}_{V} s + {K}_{V}} ) \cdot θ & ( 6 ) \\ {V}_{H} = \{ \begin{matrix}\frac{\begin{matrix}{J}_{M} {J}_{L} {s}^{5} + ( {J}_{M} {D}_{L} + {J}_{L} {D}_{M} + {K}_{V} {J}_{L} ) {s}^{4} + \\ ( {D}_{M} {D}_{L} + {K}_{V} {D}_{L} + \frac{{K}_{V} {J}_{L}}{{T}_{V}} ) {s}^{3} + \frac{{K}_{V} {D}_{L}}{{T}_{V}} {s}^{2}\end{matrix}}{{C}_{L} s + {K}_{L}} + \\ ( {J}_{M} + {J}_{L} ) {s}^{3} + ( {D}_{M} + {D}_{L} + {K}_{V} ) {s}^{2} + \frac{{K}_{V}}{{T}_{V}} s\end{matrix} \} \cdot ( \frac{{T}_{V}}{{K}_{V} {T}_{V} s + {K}_{V}} ) \cdot θ & ( 7 )\end{matrix}$$

It is not possible to organize the original Formula (7) in terms of the differential orders. However, the following Formula (8) is obtained by deleting the term C_{L}, which has little effect on accuracy, from Formula (7). A portion on the right side of Formula (8) excluding θ constitutes a transfer function for compensation control. The following Formula (9) is obtained by replacing Formula (8) with the coefficients a1 to a5. In this way, the coefficients a1 to a5 are obtained from Formula (8) and Formula (9).

$$\begin{matrix} [ Expression 5 ] & \\ {V}_{H} = \{ \frac{{J}_{M} {J}_{L} {s}^{5}}{{K}_{L}} + \frac{( {J}_{M} {D}_{L} + {J}_{L} {D}_{M} + {K}_{V} {J}_{L} ) {s}^{4}}{{K}_{L}} + ( {J}_{M} + {J}_{L} + \frac{{D}_{M} {D}_{L} + {K}_{V} {D}_{L}}{{K}_{L}} + \frac{{K}_{V} {J}_{L}}{{T}_{V} {K}_{L}} ) {s}^{3} + ( {D}_{M} + {D}_{L} + {K}_{V} + \frac{{K}_{V} {D}_{L}}{{T}_{V} {K}_{L}} ) {s}^{2} + \frac{{K}_{V}}{{T}_{V}} s \} \cdot ( \frac{{T}_{V}}{{K}_{V} {T}_{V} s + {K}_{V}} ) \cdot θ & ( 8 ) \\ {V}_{H} = ( a 1 s + a 2 {s}^{2} + a 3 {s}^{3} + a 4 {s}^{4} + a 5 {s}^{5} ) \cdot ( \frac{{T}_{V}}{{K}_{V} {T}_{V} s + {K}_{V}} ) \cdot θ & ( 9 )\end{matrix}$$

### INDUSTRIAL APPLICABILITY

The present invention relates to a load inertia estimation method and a control parameter adjustment method, which is useful for application to the case of adjusting load inertia included in an inverse characteristic model of a feed system that is added to a feedback control system of a machine tool and the like.

### EXPLANATION OF REFERENCE NUMERALS

1 bed
2 table
21 feedback control system
22 feed system
23 servo motor
24 reduction gear unit
24a motor end gear
24b load end gear
25 bearing
26 bracket
27 ball screw
27a screw portion
27b nut portion
28 position detector
29 pulse encoder
31 position deviation operating unit
32 multiplication unit
33 velocity deviation operating unit
34 proportional integral operating unit
35 current control unit
36 differential operating unit
41 NC device
50 inverse characteristic model
51 first-order differential term operating unit
52 second-order differential term operating unit
53 third-order differential term operating unit
54 fourth-order differential term operating unit
55 fifth-order differential term operating unit
56 addition unit
57 proportional integral inverse transfer function unit
60 load inertia estimation model
64 torque deviation operating unit
62, 63 blocks of transfer functions concerning servo motor
64, 65, 66 blocks of transfer functions concerning table and ball screw
67 position deviation operating unit
70 position deviation characteristic data unit

1. A load inertia estimation method of estimating load inertia of a feed system for a load position control system configured to cause a feedback control system, to which an inverse characteristic model of the feed system is added, to control a load position of the feed system on the basis of an amount of compensation outputted from the inverse characteristic model and used for compensating for a dynamic error factor of the feed system, the method characterized in that the method comprises:
in the load position control system, conducting a load position control test using the feedback control system by issuing a position command to the feedback control system, and measuring a position deviation between the position command and the load position arising at a prescribed load position at this time; and
in a load inertia estimation model being a model of the load position control system, conducting load position control simulation on a model of the feed system using a model of the feedback control system by issuing the position command to the model of the feedback control system, repeating the load position control simulation while the load inertia included in the model of the feed system is adjusted until a position deviation between the position command and the load position arising at the prescribed load position in the load position control simulation becomes equal to the position deviation measured in the load position control test, and as a consequence, if the position deviation arising at the prescribed load position in the load position control simulation becomes equal to the position deviation measured in the load position control test, estimating the load inertia included in the model of the feed system at this time as the load inertia of the feed system.

2. A load inertia estimation method of estimating load inertia of a feed system for a load position control system configured to cause a feedback control system, to which an inverse characteristic model of the feed system is added, to control a load position of the feed system on the basis of an amount of compensation outputted from the inverse characteristic model and used for compensating for a dynamic error factor of the feed system, the method characterized in that the method comprises:
in the load position control system, conducting a load position control test using the feedback control system by issuing a position command to the feedback control system and measuring a position deviation between the position command and the load position arising at a prescribed load position at this time, or in a model of the load position control system, conducting load position control simulation on a model of the feed system using a model of the feedback control system by issuing the position command to the model of the feedback control system and measuring the position deviation between the position command and the load position arising at the prescribed load position at this time; and
finding load inertia corresponding to the position deviation measured in the load position control test or the load position control simulation on the basis of position deviation characteristic data which is preset based on the position deviation between the position command and the load position being measured in advance and arising at the prescribed load position when no load is applied and on the position deviation between the position command and the load position being measured in advance and arising at the prescribed load position when a certain load is applied and which increases linearly in proportion to an increase in the load inertia, and estimating the load inertia thus found as the load inertia of the feed system.

3. A control parameter adjustment method of adjusting load inertia included in an inverse characteristic model for a load position control system configured to cause a feedback control system, to which the inverse characteristic model of a feed system is added, to control a load position of the feed system on the basis of an amount of compensation outputted from the inverse characteristic model and used for compensating for a dynamic error factor of the feed system, the method characterized in that the method comprises adjusting the load inertia included in the inverse characteristic model on the basis of the load inertia estimated by the load inertia estimation method according to claim 1.

4. A control parameter adjustment method of adjusting load inertia included in an inverse characteristic model for a load position control system configured to cause a feedback control system, to which the inverse characteristic model of a feed system is added, to control a load position of the feed system on the basis of an amount of compensation outputted from the inverse characteristic model and used for compensating for a dynamic error factor of the feed system, the method characterized in that the method comprises adjusting the load inertia included in the inverse characteristic model on the basis of the load inertia estimated by the load inertia estimation method according to claim 2.
